(19) United States
(12) Patent Application Publication
(10) Pub. No.: US 2023/0092077 A1
(43) Pub. Date: Mar. 23, 2023

(54) COMPOSITIONS AND METHODS FOR RESTORATION OF A LOW-SLOPED ROOF

(71) Applicant: Roof-X Roofing, LLC, Commerce City, CO (US)

(72) Inventors: Brad LORENZEN, Commerce City, CO (US); Jim NEVIN, Palm Beach Gardens, FL (US)

(21) Appl. No.: 17/933,569

(22) Filed: Sep. 20, 2022

Related U.S. Application Data
(60) Provisional application No. 63/246,649, filed on Sep. 21, 2021.

(51) Int. Cl. C08L 95/00; C09J 195/00

(52) U.S. Cl. CPC C08L 95/00; C09J 195/00; C08L 2555/22; C08L 2555/84

(57) ABSTRACT

Asphalt-based compositions for use in the restoration of low-sloped roofs. Compositions are a unique combination of PG asphalts, elastomers, plastomers, plasticizers, and waxes having the unique physical property of providing a functional membrane that can be applied over existing roofing membranes and materials.

### CROSS-REFERENCE TO RELATED APPLICATIONS

This application claims priority to the U.S. Provisional Application No. 63/246,649, filed on Sep. 21, 2021, entitled “COMPOSITIONS AND METHODS FOR RESTORATION OF A LOW-SLOPED ROOF”. The contents of all of the above-noted applications are incorporated herein by reference as if set forth in full and priority to these applications is claimed to the full extent allowable under U.S. law and regulations.

### TECHNICAL FIELD OF THE INVENTION

Embodiments of the present invention relate to bitumen-based adhesive compositions and uses thereof, and in particular, relate to bitumen-based compositions used to restore low-sloped roofs.

### BACKGROUND OF THE INVENTION

A flat or low-slope roof requires replacement about every ten to forty years, depending on the quality and type of roofing materials used to install the roof, the seasonal weather conditions on the roof, and damage done to the roof over time, e.g., wind, hail, falling tree limbs, construction materials, etc. Roof replacement can be costly and labor intensive and often requires the old roof to be partially or completely torn-off and disposed of in an environmentally approved manner. In addition, new roof installations require up-to-code replacement, a significant cost as compared to restoration of the existing roof.

In this light, there are several current roof options for a low-slope roof, including: tar and gravel, torch-down, and rolled roofing. In tar and gravel roofs, there are alternate layers of bitumen and reinforced fabric topped with gravel. When a tar and gravel roof is replaced, the existing bitumen and reinforced fabric must be torn-off and replaced, a labor intensive, costly and time-consuming procedure. Removed materials are deposited in a landfill, also resulting in an adverse environmental impact. A torch-down roof is a bitumen membrane sealed by propane torch during its installation. Like the tar and gravel roof, a torch-down roof requires intense labor, and in this case, intense labor using propane torches (or other like devices). As with the tar and gravel roof, the old roofing materials must be torn off and disposed of in an environmentally approved manner. Other roof options, like rolled roofing, a peel and stick membrane made from a material much like asphalt shingles, require intense labor for removal and environmentally appropriate disposal of the original roofing materials, as well as measurements for placing the cut roofing membrane on the roofing deck to avoid any leakage or missed surface.

In each of the above described flat or low-sloped roof options, labor, time, material removal cost, new material cost, new code requirements, and environmental impact are of concern. New low cost and environmentally friendly restoration options are needed in the art. Of interest in this art are the following patent applications, patents and references.

U.S. patent application no. 20060223916 (2006 Stuart, et. al.) discloses the use of at least one each of a plastomer, an elastomer and asphalt.

U.S. Pat. No. 10,941,296 (2021 Gryzbowski et al.) discloses the use of elastomers and elastomers along with refined engine oil and ground tire rubber for use in asphalt paving, roofing and industrial applications.

“Use of plastomeric additives to improve mechanical performance of warm mix asphalt” by: Michael Lecomte et. al. Jun. 3, 2016.

It is against this backdrop that the present disclosure is provided.

### SUMMARY OF THE INVENTION

Embodiments in accordance with the disclosure include novel asphalt- or bitumen-based compositions for use in restoring low-sloped roofs. These compositions, once applied, include a unique combination of components that exhibit enhanced adhesion durability, elasticity, moisture resistance and other useful roofing characteristics. The compositions can also be applied to various surfaces for road paving, waterproofing, adhesion, sound dampening, shock resistance (particularly in flooring), thermal insulation, heat transfer and the like.

In one embodiment, compositions for use as a roofing adhesive, include a Performance Grade (PG) asphalt at from about 60 to 99 weight % (wt. %), an elastomer at from about 1 to 20 wt. %; and a plastomer at from about 0 to 10 wt. % of the composition. These compositions are prepared to form a storage stable adhesive roofing matrix. The composition can further include a plasticizer at from about 0 to 10 wt % of the composition and/or a wax at from about 0 to 10 wt. % of the composition. Further embodiments may also include synthetic hydrocarbon resin tackifiers at from about 0 to 10%, natural resin tackifiers at from about 0 to 10%, surfactants at from about 0 to 5%, flame retardants from about 0 to 5% and inert fillers from about 0 to 20%.

The PG asphalt herein can be PG 58-28, PG 64-22, or mixtures thereof, the elastomer herein can be linear SBS, radial SBS, SEBS, SSBR, SIS or mixtures thereof, the plastomer herein can be polyolefin/alpha olefin, isotactic propylene-ethylene, ethylene copolymer resin, olefin block copolymers or mixtures thereof, the plasticizer herein can be an bio-based oil, paraffinic oil, naphthenic oil, aromatic oil or mixtures thereof, and the wax can be Fischer-Tropsch/synthetic paraffin, microcrystalline, polyethylene, slack or mixtures thereof. Suitable fillers for this application include but are not limited to carbon black, calcium carbonate, cellulose fibers, ground tire rubber, talc, diatomaceous earth, ground glass and ground shingles.

In another embodiment herein, methods for restoring a low-slope roof are provided that include pressure washing an exterior surface or deck of the existing low-slope roof, providing a composition as disclosed herein, heating the composition to between about 400° and about 440° F. in a kettle or other like container and applying the heated composition to the washed exterior surface/deck of the existing low-sloped roof. In some cases, within a short time frame of applying the heated composition, applying an appropriate amount of roofing granules. In other aspects, the application of the heated composition to the exterior surface/deck of the low-sloped roof is with a squeegee or mop.

The method embodiments herein can also include heat-scanning the pressure washed exterior surface/deck of the low-sloped roof to identify damaged areas in need of repair prior to applying the heated compositions above. In these instances where there is damage, performing the necessary repairs before applying the heated composition. These repairs may not include tearing off the old roofing materials. In fact, some methods herein do not include removal of existing roof materials prior to application of the heated composition.

In another embodiment, a method for producing a composition in accordance with embodiments herein include heating a PG asphalt to about 375° F. and adding an elastomer to the heated PG asphalt, mixing the PG asphalt and elastomer for an amount of time, and removing a sample to identify the degree of dispersion and integration of the components. Upon acceptable dispersion and integration, a plastomer is added to the heated PG asphalt and elastomer with mixing, and then a plasticizer or wax is added with mixing. Prepared compositions can be packaged for storage or used as a restorative low-slope roof.

Compositions described herein can also be used to spot repair a leaky or damaged roof, damaged gutters or pipes, a boat deck or hull, as a shock absorption material on flooring, or as an automobile insulator, a sound dampening membrane, or heat-transfer membrane.

### DETAILED DESCRIPTION OF THE INVENTION

Definitions

As used herein, “bitumen” refers to a black viscous mixture of hydrocarbons obtained naturally or as a residue of petroleum distillation.

As used herein, “elastomers” refers to materials disclosed herein that increase the flexibility, shock resistance, and elasticity of a low-sloped roof.

As used herein, “low-sloped roof” refers to a roof having no greater than 4 inches of pitch for every 12 inches of run, and more typically, 1 to 3 inches of pitch for every 12 inches of run, and can include what is considered a roof having a pitch of less than 1 inch for every 12 inches of run down to a roof considered dead level.

As used herein, “plasticizer” refers to materials disclosed herein that reduce the brittleness and increase flexibility of low-sloped roofs particularly at low temperatures.

As used herein, “filler” refers to materials disclosed that are solid finely dispersed particles that alter the physical nature of the coating composition and impart special properties as needed for the intended application.

As used herein, “plastomers” refers to polymeric materials disclosed that improve suspension and solution durability while maintaining physical aspects of both a plastic and an elastic polymer.

As used herein, “roofing granules” refers to crushed rock, porcelain, slag, tile and the like used for coating of the applied compositions. Granules can be reflective or absorptive to enhance either heat retention or heat reflection of the low-sloped roof.

As used herein, “wax” refers to materials disclosed herein that alter the physical properties of hardness, tack and softening point of low-sloped roofs. The use of waxes can also reduce the application temperature of the compound thereby reducing the emission of Volatile Organic

Compounds and the energy required to melt and apply the product.

### Embodiments

Embodiments in accordance with the present invention include compositions for use in restoring a low-sloped roof, and methods for using the compositions to restore a low-sloped roof in a more efficient and labor friendly manner. Embodiments also include use of the compositions for road paving, waterproofing, adhesive applications, insulation, shock absorption, sound dampening, heat-transfer, and the like.

Compositions in accordance with embodiments herein may include PG asphalts, including oxidized PG-asphalts, elastomers, plastomers, plasticizers and waxes. Compositions are combined under heat and agitation to allow for full dispersal and integration of the ingredients.

Innovative compositions herein are a unique combination of materials that allow low-sloped roofs to be restored and not replaced. Compositions herein, once applied in a liquid state, under heat, and subsequently cured, adhere to the underlying and existing roofing materials, integrating into and forming a durable, flexible, and elastic waterproof membrane, that adds a significant number of years to the utility of the existing low-sloped roof. As can be imagined, compositions herein can also be used or applied to the deck of a new roof, or to any exterior surface, in need of a composition utility. Importantly, restoration embodiments do not require tear-off of the old or existing roof, thereby reducing the environmental impact, and are not considered new roofing, so are outside most new roofing code requirements, i.e., the old low-sloped roof is restored and not replaced.

Compositions can also be used on any surface in need of waterproofing, shock absorption on flooring, insulation, soundproofing, and/or the like. For example, a surface in need of an adhesive membrane to waterproof an underlying damaged structure from moisture, like spot application on any roof, bathroom, gutter, boat deck, and the like. Compositions can also be used in automotive insulation and underbody anti-corrosion applications, as an adhesive on pipe joints, outdoor pipe insulation in residential and industrial applications, natural gas and oil pipeline repair, as a shock absorption material on commercial and residential flooring, and the like.

Novel Asphalt-Based Compositions

As an initial defining point, asphalt or bitumen is primarily produced during the distillation process of selected crude oils which contain chemical compounds critical to the necessary physical properties of its intended uses. Asphalt is the principal component in several critical construction materials including asphalt pavement binders, asphalt roofing compounds including shingles and single ply membranes and asphalt emulsions which are used in paving, roofing and waterproofing products.

Asphalt resin as produced during the refining process of crude oil does not possess many of the critical physical properties necessary for use in its intended applications, particularly those pertaining to modern paving and roofing formulations. The physical stresses and environmental factors that asphalt based products are exposed to during their intended life cycle requires the inclusion of high-performance additives designed with specific proclivities for use with the unique combination of chemical and physical properties of asphalt. As described herein, these additives improve asphalt by increasing it resistance to deformation and fatigue and increasing its ductility, elasticity, softening point and adhesion among other properties. The identification of such improvements in the asphalt is a surprising and significant improvement in the art.

Embodiments in accordance with the present disclosure, therefore, include a novel combination of one or more Performance Graded (PG) asphalts (including oxidized PG asphalts) and one or more elastomers, combined optionally with one or more plastomers, one or more plasticizers, one or more waxes, one or more surfactants, one or more flame retardants and one of more inert fillers In some embodiments, the compositions include at least one or more PG asphalts, one or more elastomers, and one or more plastomers and optionally one or more plasticizers one or more waxes, one or more surfactants, one or more flame retardants and one of more inert fillers. In still other embodiments, the compositions include one or more PG asphalts, one or more elastomers, one or more plastomers, and one or more plasticizers and optionally one or more waxes, one or more surfactants, one or more flame retardants and one of more inert fillers. In still other embodiments in accordance with the present disclosure, novel combinations of one or more PG asphalts, one or more elastomers, one or more plastomers, one or more plasticizers, one or more waxes and optionally one or more surfactants, one or more flame retardants and one of more inert fillers are provided.

It is noted that it is also envisioned that embodiments herein can include one or more PG asphalts, one or more elastomers, one or more plasticizers or waxes and optionally one or more plastomers, one or more surfactants, one or more flame retardants and one of more inert fillers.

The compositions herein, prepared as described below, provide for a restorative low-sloped roofing, as well as a waterproofing, insulating, sound dampening, adhesion, shock absorption, and heat-transfer material coatings.

Performance Grade (PG) Asphalt materials for use herein include bitumen-based materials, including PG 58-28, PG 64-22, mixtures of PG 58-28 and PG 64-22, and other like bitumen-based asphalts. In typical embodiments the asphalt comprises from about 60% to about 99% by weight of the composition, more typically from about 69% to about 93% by weight of the composition, and most typically from about 78% to about 88% by weight of the composition.

In an alternative embodiment, the PG asphalt above is oxidized prior to use. Oxidized asphalt is prepared by running air or oxygen (in an oxidation or air blowing process) through heated PG asphalt, typically from 420°-460° F., to form oxygen containing chemical compounds that subsequently alter the physical properties of the original asphalt. Oxidized asphalt includes fewer impurities and provides enhanced adhesiveness to the deck surfaces described herein. In addition, oxidized asphalt, as a constituent of the compositions herein, has a raised softening point and viscosity, while maintaining flexibility at lower temperatures. This combination provides a significant benefit in the restoration of low-sloped roofs.

Elastomers for use herein typically include one or more styrene block co-polymers, including linear styrene-butadiene-styrene (SBS), radial SBS, multi-arm SBS, star SBS, linear and radial styrene-isoprene-styrene (SIS), styrene-ethylene-butylene-styrene (SEBS), and solution polymerized styrene-butadiene rubber (SSBR). The term “block copolymer” refers to the presence of repeating units of the same molecule called monomers that form blocks of common units such as styrene, butadiene, ethylene, butylene or isoprene. These blocks are then combined to form di-blocks, tri-blocks and tetra-blocks which impart unique properties to the asphalt. The term Styrenic block copolymer is used because without exception, all of the elastomeric co-polymers used in asphalt modification include polystyrene.

The Molecular Weight (MW) of the elastomers is preferably from about 60,000 daltons to about 400,000 daltons, and more preferably from about 80,000 daltons to about 360,000 daltons. In general, an elastomer comprises from about 1% to about 20% by weight of the composition, and more preferably comprises from about 4% to about 16% by weight, and most preferably from about 6% to about 12% by weight of the composition.

Regarding using specific illustrative elastomers, linear SBS for use herein typically should have a MW of from about 60,000 to about 200,000, and more typically about 80,000 to about 160,000. The linear SBS can comprise from about 1% to about 20% by weight of the composition, and more preferably from about 4% to about 16% by weight of the composition and most preferably from about 6% to about 12% by weight of the composition. Linear SBS is available from EnChuan Chemical Company, Taipei, Taiwan and Kumho Petrochemicals, Seoul, South Korea.

Radial SBS should have a MW of from about 120,000 to about 400,000, and more preferably from about 160,000 to about 360,000. The radial SBS can comprise from about 1% to about 16% by weight of the composition, and more preferably from about 2% to about 12% by weight of the composition and most preferably from about 3% to about 9% by weight of the composition. Radial SBS is available from EnChuan Chemical Company, Taipei, Taiwan and Kumho Petrochemicals, Seoul, South Korea.

SIS for use herein typically should have a MW of from about 80,000 to about 220,000, and more preferably from about 120,000 to about 180,000. The SIS can comprise from about 1% to about 20% by weight of the composition, and more preferably from about 44% to about 16% by weight of the composition and most preferably from about 6% to about 12% by weight of the composition. SIS is available from Kraton Polymers U.S. LLC, Houston, Tex. and Baling Petrochemical, Yueyang, Hunan, China.

SEBS for use herein preferably should have a MW of from about 60,000 to about 360,000, and more preferably from about 80,000 to about 220,000. The SEBS can comprise from about 1% to about 20% by weight of the composition, and more preferably from about 4% to about 16% by weight of the composition and most preferably from about 6% to about 12% by weight of the composition. SEBS is available from Dynasol LLC, Houston, Tex.

SSBR for use herein typically should have a MW of from about 60,000 to about 200,000, and more preferably from about 80,000 to about 140,000. The SSBR can comprise from about 1% to about 20% by weight of the composition, and more preferably from about 4% to about 16% by weight of the composition and most preferably from about 1% to about 4% by weight of the composition. SSBR is available from Dynasol LLC, Houston, Tex.

In some embodiments, the elastomer may be a combination or mixture of linear SBS, radial SBS, SIS, SEBS and/or SSBR. Combinations would abide by the total elastomers percent weights, and MW ranges, using a combination of two or more of the listed materials. In some aspects, a combination of any two of the elastomers can be used, or any three of the elastomers can be used, or any four of the elastomers can be used, or all five of the elastomers can be used to make-up the elastomer portion of the composition.

Given the presence of sites of unsaturation in the carbon backbone of SBS, SSBR and SIS the practice of cross-linking may be employed in order to further modify the molecular structure of these polymers. Crosslinking of Styrenic copolymer modified asphalt can be accomplished using sulfur in the form of elemental sulfur or what is referred to as sulfur donor molecules along with a catalyst such as zinc oxide and or an initiator such as ethylate zymate.

Plastomers for use herein can include polyolefin/alpha olefin, isotactic polypropylene (IPP), atactic polypropylene (APP), ethylene blend, ethylene copolymer resins, and olefin block copolymers.

In some embodiments, the plastomer is at a weight percent of from about 0 to about 10% of the composition. In alternative embodiments, the plastomer is present at from about 2% to about 8% by weight of the composition, and often can be present at from about 4% to about 6% by weight of the composition.

In one embodiment of the present invention, the plastomer is polyolefin/alpha olefin, including, for example, poly(styrene), poly(diene) and poly(ethylene). In some specific embodiments, the polyolefin/alpha olefin accounts for about 1%, 2%, 3%, 4%, 5%, 6%, 7%, 8%, 9%, or 10% by weight of the composition. Specific examples include ethylene 1-octene copolymer from Aterna LLC, Indianapolis, Ind.

In another embodiment, the plastomer is an isotactic propylene-ethylene blend. In some specific embodiments, the isotactic propylene-ethylene accounts for about 1%, 2%, 3%, 4%, 5%, 6%, 7%, 8%, 9%, or 10% by weight of the composition. Specific examples for use herein include Vistamaxx 6502 from ExxonMobil Chemical Company.

In some embodiments, the plastomer is an ethylene terpolymer resin. In some specific embodiments, the ethylene copolymer resin accounts for about 1%, 2%, 3%, 4%, 5%, 6%, 7%, 8%, 9% or 10% by weight of the composition. Specific examples for use herein include Elvaloy 4170 RET from Dow Chemical.

In still other embodiments, the plastomer is an olefin block copolymer. In some specific embodiments, the olefin block copolymer accounts for about 1%, 2%, 3%, 4%, 5%, 6%, 7%, 8%, 9% or 10% by weight of the composition.

In some embodiments, the plastomer may be a combination or mixture of polyolefin/alpha olefin, isotactic propylene-ethylene, ethylene copolymer resin, and olefin block copolymers. Combinations of plastomers would abide by the total percent weights, using a combination of two or more of the listed materials. In some aspects, a combination of any two of the plastomers can be used, or any three of the plastomers can be used, or any four of the plastomers.

Some embodiments herein include a plasticizer. Specific plasticizers can be used to improve the integration of polymers into the asphalt and the durable dispersion thereof, for example, to the

PG asphalt and increase low temperature properties like flexibility and adhesion. Plasticizers for use herein can include a bio-based oil, a paraffinic oil, a naphthenic oil an aromatic oil and/or a recycled oil product or products. In specific embodiments, the plasticizer can be TuffTrek 4002 from Georgia Pacific and/or REOB (Recycled Engine Oil Bottoms) Safety Kleen.

Plasticizer can comprise from about 0 to 10% by weight of the composition, and more preferably from 1% to about 6% by weight, and most preferably from about 1% to about 4% by weight of the composition.

In some embodiments, the plasticizer is a bio-based oil. In some specific embodiments, the bio-based oil accounts for about 1%, 2%, 3%, 4%, 5%, 6%, 7%, 8%, 9% or 10% by weight of the composition.

In other embodiments, the plasticizer is a paraffinic oil. In some specific embodiments, the paraffinic oil accounts for about 1%, 2%, 3%, 4%, 5%, 6%, 7%, 8%, 9% or 10% by weight of the composition.

In still other embodiments, the plasticizer is a naphthenic oil. In some specific embodiments, the naphthenic oil accounts for about 1%, 2%, 3%, 4%, 5%, 6%, 7%, 8%, 9% or 10% by weight of the composition.

In still other embodiments, the plasticizer is an aromatic oil. In some specific embodiments, the naphthenic oil accounts for about 1%, 2%, 3%, 4%, 5%, 6%, 7%, 8%, 9% or 10% by weight of the composition.

In some embodiments, the plasticizer may be a combination or mixture of bio-based oil, paraffinic oil, naphthenic oil, and aromatic oil. Combinations would abide by the total plasticizer percent weights, using a combination of two or more of the listed materials. In some aspect, a combination of any two of the plasticizers can be used, or any three of the plasticizers can be used, or any four of the plasticizers to make-up the total amount in the composition.

Some embodiments herein also include a wax. Inclusion of a wax to compositions herein increase the physical properties of hardness and softening point. Waxes can include a Fischer-Tropsch/synthetic paraffin, microcrystalline, polyethylene and slack. In specific embodiments, the wax can be Tektavo from Sasol Wax.

Waxes can comprise from about 0 to 10% by weight of the composition, and more preferably from 1% to about 6% by weight, and most preferably from about 1% to about 4% by weight of the composition.

In one embodiment, the wax is Fischer-Tropsch/synthetic paraffin. In some embodiments, the Fischer-Tropsch/synthetic paraffin accounts for about 1%, 2%, 3%, 4%, 5%, 6%, 7%, 8%, 9% or 10% by weight of the composition.

In another embodiment, the wax is a microcrystalline wax. In some embodiments, the microcrystalline wax accounts for about 1%, 2%, 3%, 4%, 5%, 6%, 7%, 8%, 9% or 10% by weight of the composition. Microcrystalline wax is available from Industrial Raw Materials, New York City.

In another embodiment, the wax is a polyethylene wax. In some embodiments, the polyethylene wax accounts for about 1%, 2%, 3%, 4%, 5%, 6%, 7%, 8%, 9% or 10% by weight of the composition. Polyethylene Wax is available from PMC Crystal, Lansdale, Pa.

In yet another embodiment, the wax is a slack wax. In some embodiment, the slack wax accounts for about 1%, 2%, 3%, 4%, 5%, 6%, 7%, 8%, 9% or 10% by weight of the composition. Slack wax is available from Industrial Raw Materials, New York City.

In some embodiments, the wax may be a combination or mixture of Fischer-Tropsch/synthetic paraffin wax, microcrystalline wax, polyethylene wax and slack wax. Combinations would abide by the total wax percent weights, using a combination of two or more of the listed materials. In some aspects, a combination of any two of the waxes can be used, or any three of the waxes can be used, or all four of the waxes.

Some embodiments herein also include a Surfactant. Inclusion of a surfactant or surfactants to compositions herein increase the chemical properties of the composition so as to improve its adhesion to mineral granules and aggregates. Suitable surfactants include mono and poly amine derivatives of animal fat, vegetal substances comprised of fatty acids and esters and silane derivatized nanotechnology. These products are used as adhesion promotors also known as anti-strip additives which improve the adherence of granules and aggregates to the composition.

Surfactants can comprise between 0 and 5% of the total compositional weight and more preferably between 0.05 and 2% and most preferably between 0.1 and 1%.

In one embodiment the surfactant is an aliphatic diamine derived from animal fat also called tallow which is a triglyceride that can be reacted with sodium or potassium hydroxide to form sodium and potassium salts of the resulting fatty acid. The fatty acid is further reacted with ammonia in the presence of a metal oxide catalyst to form the nitrile derivative which can be hydrogenated to form the amine derivatives thereof. In some embodiments the tallow diamine accounts for about 0.2%, 0.3%, 0.4%, 0.5%, 0.6%, 0.7%, 0.8%, 0.9% or 1% by weight of the composition. Aliphatic amines are available from Ceca, Colombes Cedex, France.

In another embodiment the surfactant is a carboxylic acid and/or ester derived from the triglycerides of vegetable oils or animal fat. In some embodiments the carboxylic acid or ester accounts for about 0.2%, 0.3%, 0.4%, 0.5%, 0.6%, 0.7%, 0.8%, 0.9% or 1% by weight of the composition. Vegetable oils based fatty acids and esters are available from Ravago Chemicals, Orlando, Fla.

In another embodiment, the surfactant is an organo-silane dispersion based on nano-technology and accounts for about 0.05%, 0.06%, 0.07%, 0.08%, 0.09% and 0.1% by weight of the composition. Organo-silane dispersions are available from Ravago Chemicals.

Some embodiments herein also include the use of a flame retardant which serves the purpose of reducing the effects of fire or flame on the composition. Suitable flame retardants include Ammonium Polyphosphate, which is available from THOR, UK.

In one embodiment of the present invention the ammonium polyphosphate flame retardant accounts for between 0 and 5% by weight of the composition, in a preferred embodiment between 0.5 and 3% and in a most preferred embodiment between 1 and 2%.

Some embodiments herein also include the use of natural or synthetic resin tackifiers which improve the adhesion of the composition to a substrate such as an aged roof deck, a wall, a mechanical structure or a road surface. Suitable tackifiers include hydrocarbon resin tackifiers based on styrene, piperylene and dicyclopentadiene and natural tackifiers based on wood resins and rosins.

Suitable natural or synthetic resin tackifiers may comprise between 0 and 20 percent of the total compositional weight and more preferably between 1 and 10% of the total compositional weight and most preferably between 2 and 5% of the total compositional weight.

In one embodiment the natural or synthetic resin tackifier is an aromatic synthetic hydrocarbon resin based on the polymerization of unsaturated hydrocarbon feedstocks the monomers of which can be indene, methylindene, dicyclopentadiene, styrene and alpha-methylstyrene. These polymeric resis can have a molecular weight of between 300 and 3,000 Daltons.

In another embodiment the synthetic resin is an aliphatic resin synthecised from C-5 piperylene diclopentadiene and there derivates. These resins can have a molecular weight of between 300 and 3,000 Daltons.

In another embodiment the tackifier is a naturally occurring resin based on wood rosin which is derived principally from pine trees among others but mostly in the conifer family of trees and plants. The naturally occurring rosins of the present invention consist primarily of resin acids, mainly abietic acid which may be used neat or may be modified by the reaction of the rosin with chemical structures containing hydroxyl or anhydride group moieties. Such molecules include but are not limited to glycerol, pentaerythritol and maleic anhydride.

Synthetic hydrocarbon resins of the present invention are available from ExxonMobil, BASF, Cray Valley and Eastman Chemical.

Illustrative embodiments of the invention include the following compositions in accordance with the description herein:

A fully dispersed composition having 87 wt. % PG 64-22, 7 wt % SEBS, 4 wt % polyolefin, and 2 wt % aromatic oil.

A fully dispersed composition having 88% by wt of PG 64-22, 5% by wt of Calprene 6410P, 2% by wt of Tufftrek 4002 and 5% by wt of ethylene-1-octene copolymer.

In addition, the various embodiments of this invention may incorporate the use of many different types of Bitumen (Asphalt) including although not limited to: PG bitumen, roofing flux, oxidized bitumen (to various level types) and natural (Gilsonite) bitumen.

Similarly, the various embodiments of this invention may include additives commonly used in the modification of roofing and paving bitumen products such as poly phosphoric acid, chemical anti-strip additives such as fatty amines, polyamines, amidoamines, hydrated lime, and phosphate esters along with recycled additives such as ground tire rubber and ground asphalt shingles.

Methods of Preparing Roofing Compositions

Embodiments herein include methods for preparing a composition for use in restoring a low-sloped roof. Initially, the low-slope roof surface area is calculated so as to identify the approximate amount of composition required to cover a low-slope roof deck. In order to determine the approximate amount, various target thicknesses are considered. Embodiments herein can be applied to a thickness of between, for example, 70 mm to 120 mm (approximately between about 0.075 to about 0.1 inches). A thicker composition will provide a longer restorative value. As can be imagined, other thicknesses can be used, based on the proposed use and utility required.

Based on the above amount, in an appropriate container, an amount of the PG asphalt material corresponding to 60% to 99% by weight of the final composition is added and heated to from about 330 and 430° F., and more typically 350 to 400° F., and most typically approximately 385° F.

Where an oxidized asphalt is needed, the PG asphalt is initially heated with air (or oxygen) being blown through the heated composition. Oxidation takes from 1 to 120 minutes, in this situation, the PG asphalt is heated to approximately 450° F. for oxidation.

Once the asphalt is heated to temperature, an amount of elastomer is measured out based on 1% to about 20% by weight of the composition. The elastomer is added to the heated asphalt with mixing and/or recirculation (from about 500 rpm to 650 rpm) for about 1 to 6 hours, more typically for about 2 to 4 hours and most typically about 3 hours depending upon chemical compatibilities between the elastomer and asphalt, the temperature of the asphalt, the particle size of the dry elastomer and the amount of physical shear applied by the mixer. In one embodiment, the mixing is accomplished using a three inch diameter Cowles blade. Once thoroughly mixed or recirculated, a small sample is taken from the heated composition to determine, under microscopic inspection (UV microscope for example), if the combination is fully dispersed and chemically integrated into the asphalt. If the composition is not fully dispersed and integrated, the PG asphalt and elastomer is left at heat and mixing is continued, until a sample shows the appropriate dispersion and integration.

Once the elastomer is fully dispersed and integrated, the temperature of the composition is reduced by about 20° F. and between 2% to 8% by wt of plastomer is slowly added to the heated dispersed composition. The plastomer is stirred or recirculated under heat, and another sample taken from the composition for inspection under microscope. Once the plastomer is dispersed, the plasticizer and/or wax is ready for addition. As above, if the plastomer is not fully dispersed, continued stirring and heating is appropriate until the dispersion in complete.

Temperature of the dispersed composition is now reduced by approximately 15° F., or in our example above, down to 350° F. From about 1% to about 7% by weight of a plasticizer is added and allowed to mix for approximately 30 minutes to 2 hours, and more typically about 1 hour. After an hour, a small sample is removed from the composition, and a softening point test is run per ASTM D36. A result of between 200 and 250° F., depending upon specific requirements for the intended application, confirms that the embodiment of the composition is complete and ready for use or for storage. Storage requires packaging in appropriate containers for asphalt-packaging, for example, composition can be immediately pumped into sample cans and, if desired, re-tested or used on a target roof.

Where wax is appropriate, from about 1% to about 7% by weight of a wax is added and allowed to mix at temperature for 1 hour. As above, a sample can be obtained from the final mixture and a softening point test run. As above, the prepared composition can be used as discussed herein or can be stored as discussed above.

Methods of Installing a New Low-Sloped Roof

Compositions in accordance with embodiments herein are prepared as disclosed above or are retrieved from storage containers and heated (also as disclosed above). In either case, the compositions are heated up to an appropriate temperature, for example from about 350° F. to about 450° F., and more typically about 440° F.

In addition, a sufficient amount of crushed roofing granule is brought to the roof for use with the heated compositions herein. Roofing granules are added to the surface of the restored roof after the heated compositions have been applied. Typically, the roofing granules are applied while the applied composition is still hot, usually within 1 to 5 minutes, so should be present at the site for addition after the composition application. In some embodiments, the roofing granules are chosen to either retain heat from sunlight on the roof, or to reflect sunlight from the roof.

Once an appropriate amount of heated composition in accordance with embodiments herein is prepared (at the place of application), it can be applied to the roof decking surface of the new low-sloped roof. The compositions herein are prepared for application in an appropriate container on top of a newly installed low-sloped roof deck. Embodiments herein have a viscosity and setting-up capacity that allows for easy (using a mop or squeegee) application, which requires significantly less time than existing technologies.

Heated composition is administered to the low-sloped roof exterior surface using a squeegee or mop to a depth of about 70 ml to about 120 ml, or other appropriate depth. The viscosity of the composition naturally allows for application using these parameters. In some embodiments, roofing granules are applied to the coated surface from about 1 to about 5 minutes after application of the composition, while the composition is curing. Roofing granules are cast by hand or in other like manner over the composition covered roof surface. Once cured, excess roofing granules can be gathered and recycled.

Methods of Restoring a Low-Sloped Roof

Embodiments herein include methods for restoring a low-sloped roof. Restoration of a low-sloped roof is a significant benefit to the industry as it eliminates the need to tear-off the existing roof and ensures that the restored roof is not under new Local, State or Federal codes requiring new standards for installing a new roof. In particular, composition embodiments herein have restorative properties and adhesion to existing roof decks not found in the prior art. For example, compositions herein include plasticizers like Tufftrek, polyolefin elastomer (POE) and SEBS, SBS or other synthetic block copolymers that combine giving the compositions herein the properties of outstanding adherence to the existing, underlying roof deck. This unique combination is not found in other roofing products and is a surprising benefit of these compositions.

As an initial aspect for restoring a low-sloped roof, a roof is inspected to ensure that the roof is considered low-sloped and, optionally, in need of restoration (as compared to total tear-off). Inspections are accomplished by a craftsman competent in such matters or other professionals acquainted with such inspections.

In no particular order, a low-sloped roof in need of restoration can be pressure washed to remove loose debris, dirt, animal and bird droppings, and the like. Prior to or after such washing, the surface can be heat scanned or visually scanned/inspected for moisture damage or other significant damage. In some embodiments, the damage can be repaired prior to application of the compositions herein. In some instances, the damage is such that it may be completed after the application of the compositions herein.

Embodiment compositions in accordance with embodiments herein are prepared as disclosed above or are retrieved from storage containers and heated (also as disclosed above). In either case, the compositions are heated up to an appropriate temperature, for example from about 350° F. to about 450° F., and more typically 440° F.

In addition, a sufficient amount of roofing granule is brought to the roof for use with the heated compositions herein. Roofing granules are added to the surface of the restored roof after the heated compositions have been applied, but before it has cured.

Once an appropriate amount of heated composition in accordance with embodiments herein is prepared (at the place of application), it can be applied to the low-sloped roof. The compositions herein are prepared for application in an appropriate container on top of a cleaned, existing roof. There is no requirement for the old roofing material be removed, rather the old roof is left in-place. This characteristic of the compositions herein, to adhere and function over the top of existing roofing materials, is a significant advancement in the art, as it avoids the time, “tear-off” cost, and adverse environmental downside to first removing the roofing materials prior to restoring the roof. It is also not a new roof, so avoids code issues inherent in replacing a roof. In this case, the roof is being restored or repaired and thus does not need to adhere to any new code requirements for new roofs. Embodiments herein have a viscosity and durability to function over previously used roofing materials.

Heated composition is administered to the previous low-sloped roof using a squeegee or mop to a depth of about 70 ml to about 120 ml. The viscosity of the composition naturally allows for application using these parameters. In some embodiments, roofing granules are applied to the coated surface from about 1 to about 5 minutes after application of the heated composition. Roofing granules are cast by hand or in other like manner over the restored roof surface. Once cooled, excess roofing granules can be gathered and recycled. A restored low-sloped roof can add a number of years to the utility of the coated roof. In some cases, the restored roof is capable of use for up to 10 additional years, up to 15 additional years, and in some cases up to 20 additional years.

Alternative Uses

Embodiments can include use of the compositions beyond restoration of an entire low-sloped roof. For example, compositions in accordance with embodiments herein can be used for waterproofing, insulation, sound dampening, heat transfer, and the like. Illustrative examples include automotive car or truck insulation, waterproofing industrial water or gas pipes, sound dampening of floors or roofs of an industrial facility, shock absorption on floors of industrial facilities, as an adhesive to connect pipe joints, etc.

One particular alternative use is application of the compositions in accordance with embodiments herein for resurfacing, restoration or improvement of bitumen- or asphalt-based road surfaces. In these embodiments, compositions are prepared the same as for law-sloped roof restoration, and are used to resurface or fill (cracks, holes, defects, etc) damaged roads. Roads having such defects can be resurfaced or have specific defect sites targeted for composition application. The compositions herein can be applied to damaged or cracked bitumen- or asphalt-based roads using known road resurfacing devices or with other techniques as described above. The compositions herein do not require removal or grinding of the existing and damaged road, but rather are applied directly to the road surface. For cracks and other like defects, the compositions are applied such that they fill at least the defect itself.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

The invention will be further described with reference to the examples described herein; however, it is to be understood that the invention is not limited to such examples.

### EXAMPLES

### Example 1

### Preparation of an Illustrative Composition in Accordance with Embodiments Described Herein

760 grams of PG 64-22 asphalt (Suncor) was heated to a temperature of 375° F. and poured into a stainless-steel mixing vessel. The mixing vessel was placed on a variable temperature hot plate located beneath a vertical axis Cowles dispersing blade fixed to a ½ inch diameter stainless steel rod. With the Cowles disperser turning at 600 rpm and generating a significant vortex, 43.2 grams of Calprene 6140P (Dynasol Elastomers) was slowly added to prevent any agglomeration during the initial dispersing process. The C 6140P was blended for 3 hours at between 375° F. and 400° F. after which time the polymer was fully integrated into the asphalt as examined by a ultra-violet light microscope. After the C-6140P was fully integrated into the asphalt, the temperature of the blend was reduced to 325° F. and while stirring at 600 rpm, 0.28 grams of Tufftrek 4002 (Georgia Pacific) was slowly added over a period of about 2 minutes. The Tufftrek was fully dispersed and homogenously blended within 5 minutes. The Tufftrek modified sample was allowed to mature while blending for 3 minutes at 325 after which time 43.2 grams of ethylene-1-octene copolymer (Aterna, LLC) was slowly added to the batch and allowed to continue mixing for 1-hour after which time the copolymer was thoroughly dispersed into a homogenous blend. The finished product was poured into a steel can for storage until testing.

### Example 1A

### Preparation of High-Tack Asphalt Adhesive using the Product of Example 1

250 grams of the product of example 1 is reheated to a temperature of 330° F. and placed under moderate shear mixing using a Cowles blade turning at 400 rpm. To the mixing tank was added 25 grams (10%) of a C5/C9 hydrocarbon resin tackifier (Wingtack 86) available from Cray Valley, which was allowed to blend for 30 minutes. The resultant product is an excellent road pavement marker for both asphalt and concrete and also as a vertical wall mirror adhesive.

### Example 1B

### Preparation of Asphalt Pavement Binder using the Product of Example 1

250 grams of the product of example 1 is reheated to a temperature of 330° F. and placed under moderate shear mixing using a Cowles blade turning at 400 rpm. To the mixing tank was added 1.25 grams (0.5%) of Ravasol APV-70 liquid antistrip agent from Ravago Chemicals Europe that is based on vegetable oil and therefore environmentally friendly.

### Example 2

### Preparation of Second Illustrative Composition

658 grams of Type II oxidized asphalt from United Asphalts, Commerce City, Colo. was added to a stainless-steel mixing vessel and heated to 415° F. using the heating and mixing equipment described in example 1. With the Cowles disperser rotating at 600 rpm and pulling a good vortex in the hot asphalt, 37.4 grams of Kraton G1654 was gradually added to the asphalt. The polymer was continuously blended for 2 hours after which time a small sample was removed and examined by an ultra-violet light microscope to check for dispersion and integration both which were positive. At this point the temperature was reduced to 385° F. and 37.4 grams of a polyolefin elastomer from Aterna was added while continuing to mix at 600 rpm. After 1 hour of mixing, the POE a homogeneous mixture was confirmed by an ultra-violet light microscopic analysis and the temperature was further reduced to 360° F. While continuing to mix at 600 rpm, 15.0 grams of Tufftrek 4002 processing oil from Georgia Pacific was added with additional mixing for 30 minutes to complete the batch.

### Example 3

### Composition Embodiments Conform to ASTM Low Temperature Flexibility Standards

Compositions in accordance with embodiments herein were tested using the approved protocol for ASTM Low Temperature Flexibility Standards. ASTM D3111 Low Temperature Flexibility Standards determine the flexibility of a hot-melt composition in accordance with embodiments herein in a sheet form under ASTM D3111 test conditions 20° F. for 24 hours. The ASTM has developed these standards as International Standards, Guides, and Recommendations issued by the World Trade Organization Technical Barriers to Trade Committee. This standard determines whether an adhesive or adhesive-like composition is able to retract/react at lower temperatures and can avoid cracking and other damage at these lower temperatures. This practice covers the determination of the flexibility of a hot-melt adhesive in sheet form under specific test conditions. This is a working practice. Its results are useful for comparing adhesives, not for absolute characterization of adhesives.

Composition embodiments herein passed all of the Low Temperature Flexibility Testing showing the utility of these materials for use as roofing materials at low temperatures, it compares favorably to other adhesives used in the roofing industry.

### Example 4

### Composition Embodiments Conform to ASTM 896-04, Chemical Resistance Standards

Compositions in accordance with embodiments herein were tested using the approved protocol for ASTM Chemical Resistance Standards. ASTM Chemical Resistance Standards determine the general effect of chemical agents on the adhesive strength of embodiments herein. The tests herein are used to identify chemical vulnerabilities of the roofing embodiments.

Tests herein were used to immerse prepared and set compositions herein to selected agents for specified times and temperatures.

### Example 5

### Composition Embodiments Conform to ASTM Heat Stability Standards

Compositions in accordance with embodiments herein were tested using the approved protocol for ASTM Heat Stability Standards. ASTM D6152 Heat Stability Standards requires the sample be maintained at a temperature of 500° F. for 8 hours, evaluates hot-melt adhesives with respect to change in properties while adhesive are aged in the molten state driving hot-melt applications. These changes provide insight into the quality of the roofing material over a process of application.

### Example 6

### Composition Embodiments Prepare Roofing That Conforms to ASTM Penetration Standards

Compositions in accordance with embodiments herein were tested to determine penetration by a 1 mm diameter tapered tip probe to a semi-solid and solid cured membrane. Test temperature of 25° C. as required by ASTM D5.

### Example 7

### Composition Embodiments Conform to ASTM D92 Flash and Fire Points

Compositions in accordance with embodiments herein were tested to determine the flash point and fire point of cured membranes herein. A Cleveland Open cup apparatus was utilized in the tests. Test specimens passed the ASTM D92 testing, again showing the utility of embodiments herein.

### Example 8

### Composition Embodiments Conform to ASTM D4977/D4977M, Test Method for Granular Adhesion to Mineral Surfaced Roofing by Abrasion.

Test specimens passed the ASTM D4977/D4977M testing, again showing the utility of embodiments herein.

What is claimed:

1. A composition for use as a roofing adhesive, comprising:
a PG asphalt at from about 69 to 93 weight % (wt. %) of the composition;
an elastomer at from about 4 to 16 wt. % of the composition; and
a plastomer at from about 2 to 8 wt. % of the composition;
wherein the composition is prepared under heat, and once cooled to room temperature, forms a storage stable adhesive matrix.

2. The composition of claim 1, further comprising a plasticizer at from about 1 to 7 wt % of the composition.

3. The composition of claim 1, further comprising a wax at from about 1 to 7 wt. % of the composition.

4. The composition of claim 1, wherein the PG asphalt is PG 58-28, PG 64-22, or mixtures thereof.

5. The composition of claim 4, wherein the elastomer is a Styrenic tri-block copolymer with a linear, radial or star shaped geometry with end block domains containing repeating units of styrene and mid-block domains containing repeating units of butadiene and with a polymer number average (Mn) molecular weight range of 60,000 and 400,000 Daltons.

6. The composition of claim 4 wherein the elastomer is a Styrenic block copolymer with a linear, radial or star shaped geometry with end block domains containing repeating units of Styrene and mid-block domains containing repeating units of ethylene and butylene and with a polymer Mn molecular weight range of between 60,000 and 400,000 Daltons.

7. The composition of claim 4 wherein the elastomer is a Styrenic block copolymer with a linear, radial or star shaped geometry with end block domains containing repeating units of Styrene and mid-block domains containing repeating units of isoprene and with a polymer Mn molecular weight range of between 50,000 and 300,000 Daltons.

8. The composition of claim 4 wherein the elastomer is a Styrenic block copolymer with a linear geometry with block domains containing repeating units of Styrene and block domains containing repeating units of butadiene and with a polymer Mn molecular weight range of between 60,000 and 200,000 Daltons.

9. The composition of claim 5, wherein the plastomer is polyolefin/alpha olefin, isotactic propylene-ethylene, ethylene copolymer resin, olefin block copolymers or mixtures thereof.

10. The composition of claim 5, wherein the wax is Fischer-Tropsch/synthetic paraffin, microcrystalline, polyethylene, slack or mixtures thereof.

11. A method for restoring a low-slope roof, comprising:
pressure washing an exterior surface of the existing low-slope roof;
providing the composition of claim 7;
heating the composition of claim 7 to between 400° about 440° in a kettle or other like container;
applying the heated composition of claim 7 to the entire washed exterior surface of the existing low-sloped roof; and
within one to five minutes of applying the heated composition of claim 1, applying an appropriate amount of roofing granules to the applied composition of claim 7.

12. The method of claim 11, wherein the application of the heated composition to the exterior surface of the low-sloped roof is with a squeegee or mop.

13. The method of claim 12, further comprising:
heat-scanning the pressure washed exterior surface of the low-sloped roof to identify damaged areas in need of repair prior to applying the heated composition of claim 7; and
performing necessary repairs to identified damaged areas before applying the heated composition of claim 7; wherein,
the performing repairs to identified damaged areas does not include tearing off old or existing asphalt, tar, or polymer materials.

14. The method of claim 12, wherein the restoring of the low-sloped roof does not include any removal of existing roof materials prior to application of the heated composition of claim 7.

15. A method for producing the composition of claim 4, comprising:
heating PG asphalt to 410°;
add an elastomer to the heated PG asphalt;
continue heating the PG asphalt and elastomer for at least 15 minutes, and remove a sample to identify separation;
upon separation, add a plastomer to the heated PG asphalt and elastomer with slow stirring to form a mixture;
remove a sample and allow to cool, identify separation;
upon separation, allow mixture to cool to 380° F. and add plasticizer and/or wax, allowing for further mixing;
remove a sample to determine softening point test; and
packaging composition where the softening point test is within expected range.

16. The method for producing the composition of claim 4, wherein the PG asphalt comprises from about 69 to about 93 weight % (wt. %) of the composition.

17. The method for producing the composition of claim 15, wherein the elastomer comprises from about 4 to about 16 wt. % of the composition.

18. The method for producing the composition of claim 17, wherein the plastomer comprises from about 2 to about 8 wt. % of the composition.

19. The method for producing the composition of claim 18, wherein the plasticizer and wax each comprise from about 1 to about 7 wt. % of the composition.

20. A spot adhesive for repairing a leaky or damaged roof comprising the composition of claim 4.

21. An adhesive for repairing a leaky or damaged gutter comprising the composition of claim 4.

22. An adhesive for repairing a boat deck or hull comprising the composition of claim 4.
